(19) United States
(12) Patent Application Publication
(10) Pub. No.: US 2025/0185833 A1
(43) Pub. Date: Jun. 12, 2025

(54) Multi-Purpose Kitchen Tool

(71) Applicant: Nicholas Joseph Mineo, McKees Rocks, PA (US)

(72) Inventor: Nicholas Joseph Mineo, McKees Rocks, PA (US)

(21) Appl. No.: 18/974,685

(22) Filed: Dec. 9, 2024

Related U.S. Application Data
(60) Provisional application No. 63/609,113, filed on Dec. 12, 2023.

(51) Int. Cl. A47J 19/04; A47J 45/06; G01F 19/00

(52) U.S. Cl. CPC A47J 19/04; A47J 45/06; G01F 19/00; A47J 2203/00

(57) ABSTRACT

A multi-purpose kitchen tool including a hollow body having a distal and proximal end-including an inner wall, an outer wall, and a base at the distal end-a handle connected to the outer wall of the body, a tapered scooping edge on the proximal end of the body, opposite to the handle, a compartment releasably fixed to the base, and optional measuring indices.

### CROSS-REFERENCE TO RELATED APPLICATIONS

This application claims priority to and is a non-provisional of U.S. patent application Ser. No. 63/609,113, filed Dec. 12, 2023, the disclosure of which is hereby incorporated by reference in its entirety.

### BACKGROUND OF THE INVENTION

### Field of the Invention

This disclosure relates generally to a multi-purpose kitchen tool.

### Description of Related Art

In the culinary world there is a desire to increase productivity and efficiency. One way to do this is through creating multi-purpose kitchen tools which allow a chef to perform multiple activities without needing to switch tools.

### SUMMARY OF THE INVENTION

According to one non-limiting embodiment of the present disclosure, a multi-purpose kitchen tool may include a hollow body having a distal and proximal end—said hollow body including an inner wall, an outer wall, and a base at the distal end—a handle connected to the outer wall of the body, a tapered scooping edge on the proximal end of the body, opposite to the handle, a compartment releasably fixed to the base. The tool can be used to mash, season, sprinkle, measure, and scoop during food preparation.

Further features and aspects of the present invention will become apparent from the following detailed description of exemplary embodiments with reference to the attached drawings. As such, further non-limiting embodiments or aspects are set forth and described in the following clauses.

Clause 1: A multi-purpose kitchen tool comprising a hollow body having a distal and proximal end, the hollow body comprising an inner wall; an outer wall; a base at the distal end; and at least one opening at the proximal end; a handle connected to the outer wall of the body; a tapered scooping edge on the proximal end of the body, the taper scooping edge being opposite to the handle; and a compartment releasably fixed to the base.

Clause 2: The tool of clause 1, wherein the compartment is formed via a releasable cap that is releasably fixed to the body via mated threads.

Clause 3: The tool of clause 2, wherein the releasable cap further comprises at least one opening and a releasably sealable flap covering the at least one opening, and wherein the flap can be opened to expose the at least one opening.

Clause 4: The tool of clause 1, wherein the hollow body further comprises at least one marker to indicate a volumetric measurement.

Clause 5: The tool of clause 4, wherein the hollow body further comprises a plurality of markers designed to indicate graduated volumetric measurements.

Clause 6: A multi-purpose kitchen tool comprising a hollow body having a distal and proximal end, the hollow body comprising a cylindrically-shaped inner wall; a cylindrically-shaped outer wall; a base at the distal end; and at least one opening at the proximal end; a handle connected to the outer wall of the body; a tapered scooping edge on the proximal end of the body, the taper scooping edge being opposite to the handle; and a compartment releasably fixed to the base, wherein the cylindrically-shaped outer wall further comprises one or more raised protrusions.

Clause 7: The tool of clause 6, wherein the compartment is formed via a releasable cap that is releasably fixed to the body via mated threads.

Clause 8: The tool of clause 7, wherein the releasable cap further comprises at least one opening and a releasably sealable flap covering the at least one opening, and wherein the flap can be opened to expose the at least one opening.

Clause 9: The tool of clause 6, wherein the hollow body further comprises at least one marker to indicate a volumetric measurement.

Clause 10: The tool of clause 9, wherein the hollow body further comprises a plurality of markers designed to indicate graduated volumetric measurements.

Clause 11: The tool of clause 6, wherein the one or more raised protrusions located on the cylindrically-shaped outer wall are spiked-shaped protrusions designed to tenderize a food item.

Clause 12: The tool of clause 11, wherein the one or more raised protrusions are designed to tenderize meat, fish, or poultry.

Clause 13: A multi-purpose kitchen tool comprising a hollow body having a distal and proximal end, the hollow body comprising a cylindrically-shaped inner wall; a cylindrically-shaped outer wall; a base at the distal end; and at least one opening at the proximal end; a handle connected to the outer wall of the body; a tapered scooping edge on the proximal end of the body, the taper scooping edge being opposite to the handle; and a compartment releasably fixed to the base, the compartment having a bottom surface, wherein the bottom surface of the compartment further comprises one or more raised protrusions.

Clause 14: The tool of clause 13, wherein the compartment is formed via a releasable cap that is releasably fixed to the body via mated threads.

Clause 15: The tool of clause 14, wherein the releasable cap with protrusions can be exchanged for a releasable cap that comprises at least one opening and a releasably sealable flap covering the at least one opening, and wherein the flap can be opened to expose the at least one opening.

Clause 16: The tool of clause 13, wherein the hollow body further comprises at least one marker to indicate a volumetric measurement.

Clause 17: The tool of clause 16, wherein the hollow body further comprises a plurality of markers designed to indicate graduated volumetric measurements.

Clause 18: The tool of clause 13, wherein the one or more raised protrusions located on the bottom surface of the compartment are spiked-shaped protrusions designed to tenderize a food item.

Clause 19: The tool of clause 18, wherein the one or more raised protrusions are designed to tenderize meat, fish, or poultry.

### BRIEF DESCRIPTION OF THE DRAWINGS

FIG. 1 is an elevation view of the multi-purpose kitchen tool according to one embodiment of the disclosure;

FIG. 2 is a top view of FIG. 1 according to one embodiment or aspect of the present disclosure;

FIG. 3 is an exploded view of the multi-purpose kitchen tool according to one embodiment of the disclosure;

FIG. 4 is a bottom view the tool body of FIG. 3, before placement of a compartment on the base of the body according to one embodiment or aspect of the present disclosure;

FIG. 5 is an isometric view of the tool of FIG. 3 according to one embodiment or aspect of the present disclosure;

FIG. 6 is a bottom view of FIG. 3 according to one embodiment or aspect of the present disclosure;

FIG. 7 is a section view of a tool according to another embodiment or aspect of the present disclosure, showing measure lines;

FIG. 8 is an isometric view of the tool of FIG. 5 according to another embodiment or aspect of the present disclosure; and

FIGS. 9A and 9B is an isometric view of the tool of FIG. 5 according to another embodiment or aspect of the present disclosure.

### DETAILED DESCRIPTION OF THE INVENTION

The following description is provided to enable those skilled in the art to make and use the described aspects contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary aspects of the invention. Hence, specific dimensions and other physical characteristics related to the aspects disclosed herein are not to be considered as limiting.

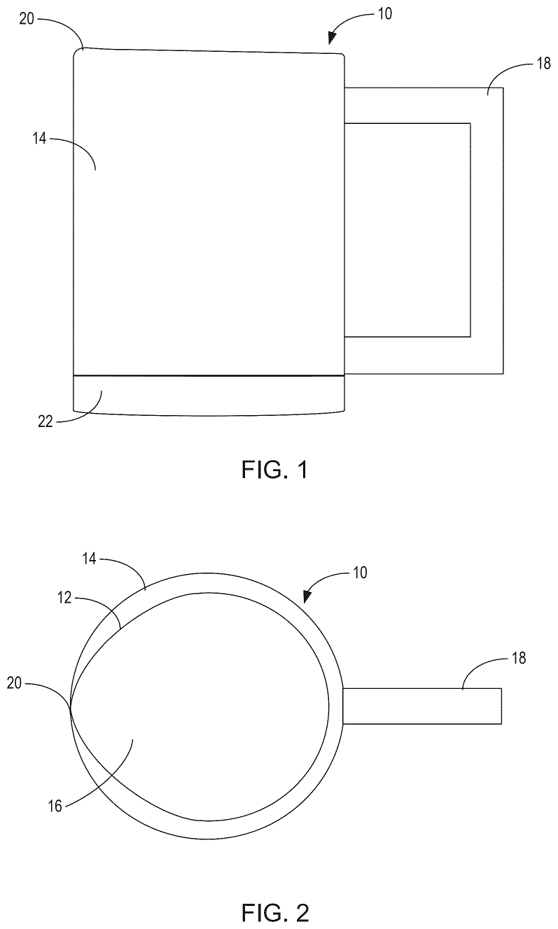

FIGS. 1 and 2 refer to a first embodiment comprising a hollow body 10 having a distal and proximal end including an inner wall 12, an outer wall 14, and a base 16 at the distal end of hollow body 10. In this embodiment, a handle 18 is connected to outer wall 14, a tapered scooping edge 20 is located on the proximal edge opposite handle 18, and a compartment 22 releasably fixed to base 16. Hollow body 10 can be any shape, such as a clenched fist, paw, rectangular prism or simply the provided cylinder. Outer wall 14 of hollow body 10 can be used for mashing or smashing food items such as potatoes or other root vegetables. Tapered scooping edge 20 is opposite handle 12 to facilitate an ergonomic motion when scooping. Scooping edge 20 can be used to scoop items such as mashed vegetables, soup, or ice cream. The vessel created by inner wall 12 and base 16 of hollow body 10 will allow for transport and deposit of the items.

Releasably fixed compartment 22 can be fixed to body 10 a number of ways including but not limited to, mated threads, rubber sealing, or internal locking. Releasably fixed compartment 22 is intended to hold items such as seasoning, spices, sauces, oils, and sprinkles.

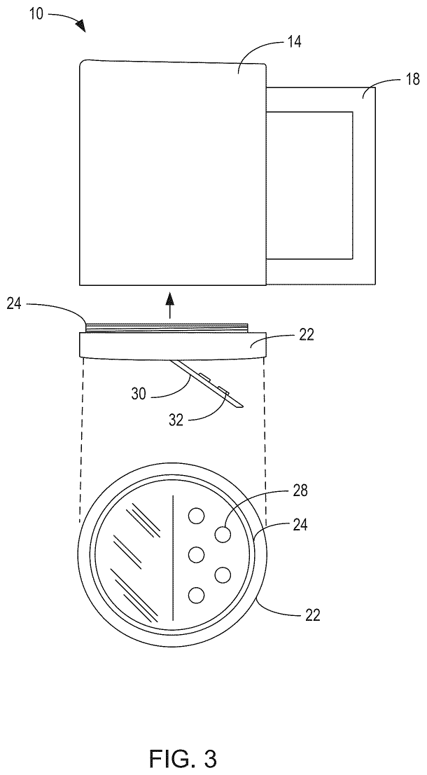

FIG. 3 refers to an embodiment where hollow body 10 has a handle 18 connected to outer wall 14 and further comprises a compartment 22 releasably fixed to base 16. In this embodiment, compartment 22 can be fixed to body 10 via mated threads 24 on compartment 22 and on body 26. Additionally, in this embodiment compartment 22 has at least one opening 28 and a releasably sealable flap 30 covering the at least one opening 28, wherein flap 30 can be opened to expose the at least one opening 28. The number and size of openings 28 can vary depending on what is held within compartment 22. For example, if the contents of compartment 22 is seasoning there might be five medium openings 28, whereas if the content is oil there might only be one small opening 28. Flap 30 can be releasably sealable in a number of ways including by plugs 32 that mate with opening 28.

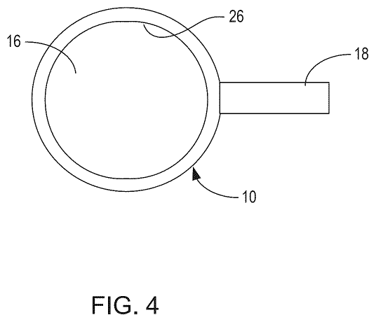

FIG. 4 refers to an embodiment where hollow body 10 with a handle 18 is connected to outer wall 14. In this embodiment compartment 22 can be fixed to body 10 via mated threads 24 on compartment 22 and on body 26. This figure illustrates the bottom of the tool with compartment 22 removed leaving base 16 and threads 26 exposed.

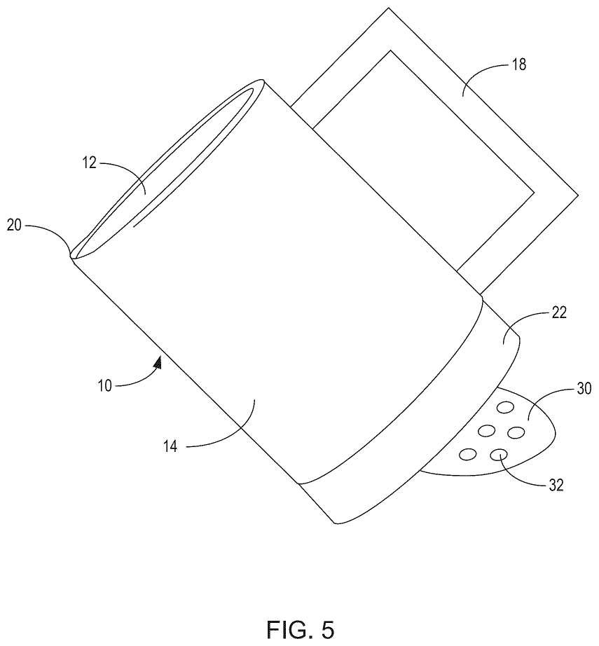

FIG. 5 refers to an embodiment where hollow body 10 has a handle 18 connected to outer wall 14 and a compartment 22 is releasably fixed to base 16. In this embodiment releasably sealable flap 30 is opened allowing for the contents of compartment 22 to come out. Tapered scooping edge 20 is shown opposite handle 18.

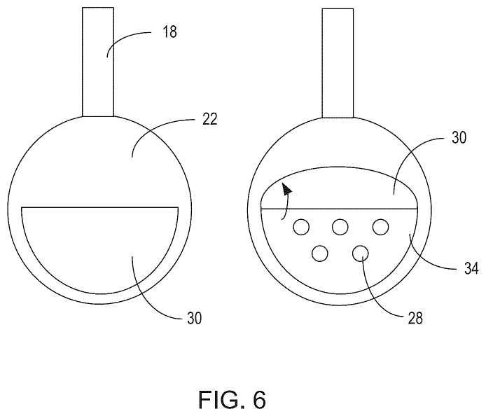

FIG. 6 refers to an embodiment where hollow body 10 has a handle 18 connected to outer wall of body 10 and a compartment 22 is releasably fixed to base 16. In this embodiment compartment 22 has at least one opening 28 and a releasably sealable flap 30 covering the at least one opening 28, wherein flap 30 can be opened to expose the at least one opening 28. Flap 30 can be releasably sealable in a number of ways including by a lip 34 in compartment 22 which flap 30 will be held when closed.

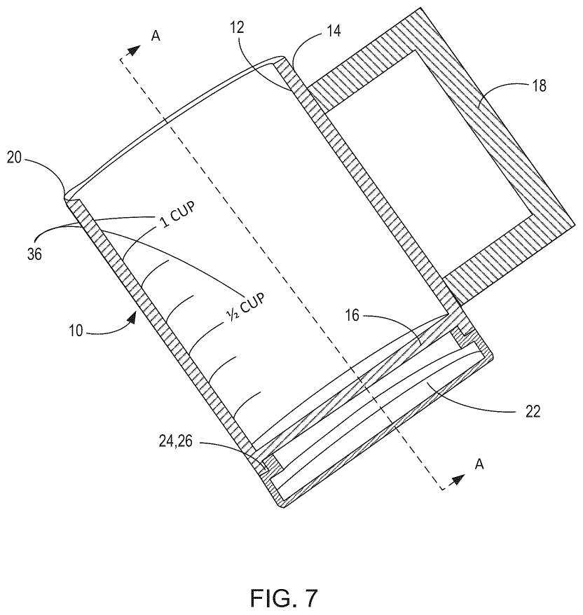

FIG. 7 refers to an embodiment where hollow body 10 has a handle 18 connected to outer wall 14 and a compartment 22 is releasably fixed to base 16. In this embodiment compartment 22 is can be fixed to body 10 via mated threads 24 on compartment 22 and on body 26. As would be apparent to those of skill in the art, the threads for compartment 22 can be located on either the interior surface of compartment 22 or the exterior surface of compartment 22. In another embodiment compartment 22 is formed due to a false bottom being formed from base 16.

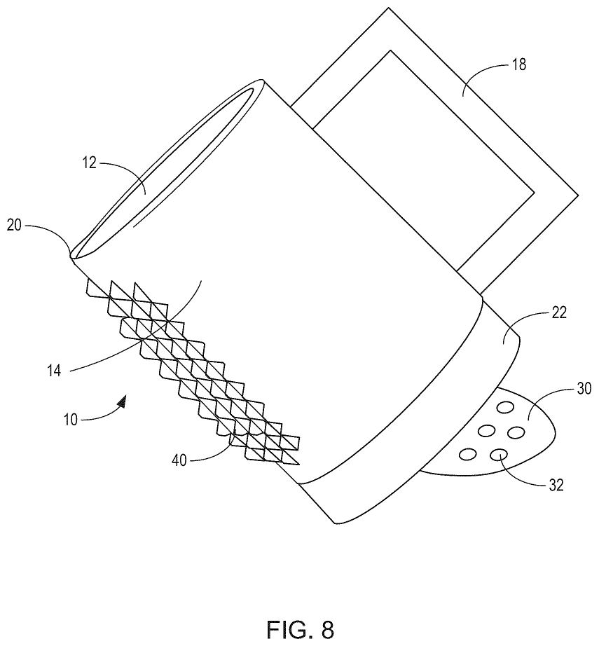

FIG. 8 refers to an embodiment, similar to the embodiment of FIG. 5, where hollow body 10 has a handle 18 connected to outer wall 14 and a compartment 22 is releasably fixed to base 16. In this embodiment hollow body has an area 40 releasably sealable flap 30 is opened allowing containing one or more raised protrusions. In one embodiment, protrusions 40 are formed from one or more raised protrusions located on the cylindrically-shaped outer wall of hollow body 10 directly opposite of handle 18 and are spiked-shaped protrusions designed to tenderize a food item. In one instance, the one or more raised protrusions 40 are designed to tenderize meat, fish, or poultry.

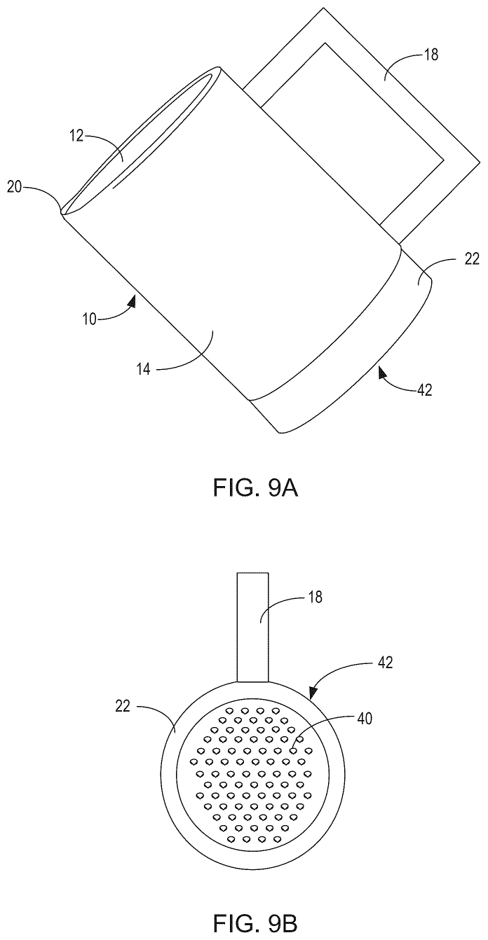

FIGS. 9A and 9B refer to an embodiment, similar to the embodiment of FIG. 5, where hollow body 10 has a handle 18 connected to outer wall 14 and a compartment 22 is releasably fixed to base 16. In this embodiment compartment 22 is covered by a tenderizer cap 42 that has an area of protrusions 40 on the bottom surface thereof. In one embodiment, protrusions 40 are formed from one or more raised protrusions located on the bottom surface of cap 42 that forms compartment 22. In another variation of this embodiment, cap 42 can be unscrewed and exchanged with the cap that forms compartment 22 in FIG. 6 where the cap of the embodiment of FIG. 6 has at least one opening 28 and releasably sealable flap 30. In one instance, the one or more raised protrusions 40 are designed to tenderize meat, fish, or poultry. As would be apparent to those of skill in the art, the shape of protrusions 40 is not critical and thus are not limited to the pyramidal-shape of FIGS. 8 and 9A, but rather can be pointed spikes, round spikes, square ended spikes, etc.

In still another embodiment, cap 42 can have both protrusions 40 as well as interspersed holes in the form of at least one opening 28 (not shown but which is a combination of the cap of FIG. 6 and that of FIG. 9B). In this embodiment, a portion of protrusions 40 are formed on releasably sealable flap 30 along with one or more openings. In still another embodiment, cap 42 has only a combination of protrusions 40 as well as interspersed holes in the form of at least one opening 28 over at least a portion, or even all, of the area covered by protrusions 40 and lacks a releasably sealable flap 30. In this case additional spices, seasonings, herbs, or some other powder is placed into compartment 22 by unscrewing cap 42 from base 16. This process can be repeated if more spices, seasonings, herbs, or some other powder is needed to fill compartment 22.

The hollow body 10 has at least one marking 36 to indicate a volumetric measurement. The markings 36 can be placed on the hollow body 10 in different ways including but not limited to, raised, etched, or printed, additionally, the at least one marking 36 can be on the inner wall 12, outer wall 14 or both. The at least one marking 36 can demarcate, any number of volumetric measurements including but not limited to, ¼ cup, ⅓ cup, ½ cup, 1 cup, 1 oz., 2 oz., 3 oz., 4 oz., 5 oz., 6 oz. 7 oz., 8 oz., 50 ml, 100 ml, 250 ml, or 500 ml. The at least one marking 36 allows for the tool to be used as a measuring cup. In still another embodiment, there are a plurality of markings 36 designed to indicate various graduated volumetric amounts.

Given the above, the present invention relates to the following embodiments which are exemplary in nature and are not to be construed as limiting.

In one embodiment, the present invention relates to a multi-purpose kitchen tool comprising a hollow body having a distal and proximal end where the hollow body comprises an inner wall, an outer wall, and a base at the distal end. Further, in this embodiment, there is a handle connected to the outer wall of the body, a tapered scooping edge on the proximal end of the body, opposite to the handle, and a compartment releasably fixed to the base. In another instance, the tool of this embodiment has a compartment that is releasably fixed to the body via mated threads. In another instance, the tool of this embodiment has a compartment that further comprises at least one opening, and a releasably sealable flap covering the at least one opening, wherein the flap can be opened to expose the at least one opening. In another instance, the tool of this embodiment the hollow body further comprises at least one marker to indicate a volumetric measurement.

In another embodiment, the present invention relates to a multi-purpose kitchen tool comprising a hollow body having a distal and proximal end, the hollow body comprising an inner wall, an outer wall, a base at the distal end, and at least one opening at the proximal end. Further, in this embodiment, there is a handle connected to the outer wall of the body, a tapered scooping edge on the proximal end of the body, the taper scooping edge being opposite to the handle, and a compartment releasably fixed to the base. In another instance, the tool of this embodiment has a compartment that is formed via a releasable cap that is releasably fixed to the body via mated threads. In another instance, the tool of this embodiment has a releasable cap that further comprises at least one opening and a releasably sealable flap covering the at least one opening, and wherein the flap can be opened to expose the at least one opening. In another instance, the tool of this embodiment has a hollow body that further comprises at least one marker to indicate a volumetric measurement. In another instance, the tool of this embodiment has a hollow body that further comprises a plurality of markers designed to indicate graduated volumetric measurements.

In another embodiment, the present invention relates to a multi-purpose kitchen tool comprising a multi-purpose kitchen tool comprising a hollow body having a distal and proximal end, the hollow body comprising a cylindrically-shaped inner wall, a cylindrically-shaped outer wall, a base at the distal end, and at least one opening at the proximal end. Further, in this embodiment, there is a handle connected to the outer wall of the body, a tapered scooping edge on the proximal end of the body, the taper scooping edge being opposite to the handle, and a compartment releasably fixed to the base, wherein the cylindrically-shaped outer wall further comprises one or more raised protrusions. In another instance, the tool of this embodiment has a compartment that is formed via a releasable cap that is releasably fixed to the body via mated threads. In another instance, the tool of this embodiment has a releasable cap that further comprises at least one opening and a releasably sealable flap covering the at least one opening, and wherein the flap can be opened to expose the at least one opening. In another instance, the tool of this embodiment has a hollow body that further comprises at least one marker to indicate a volumetric measurement. In another instance, the tool of this embodiment has a hollow body that further comprises a plurality of markers designed to indicate graduated volumetric measurements. In another instance, the tool of this embodiment has one or more raised protrusions located on the cylindrically-shaped outer wall that are spiked-shaped protrusions designed to tenderize a food item. In another instance, the tool of this embodiment has one or more raised protrusions that are designed to tenderize meat, fish, or poultry.

In another embodiment, the present invention relates to a multi-purpose kitchen tool comprising a multi-purpose kitchen tool comprising a hollow body having a distal and proximal end, the hollow body comprising a cylindrically-shaped inner wall, a cylindrically-shaped outer wall, a base at the distal end, and at least one opening at the proximal end. Further, in this embodiment, there is a handle connected to the outer wall of the body, a tapered scooping edge on the proximal end of the body, the taper scooping edge being opposite to the handle, and a compartment releasably fixed to the base, the compartment having a bottom surface, wherein the bottom surface of the compartment further comprises one or more raised protrusions. In another instance, the tool of this embodiment has a compartment that is formed via a releasable cap that is releasably fixed to the body via mated threads. In another instance, the tool of this embodiment has a releasable cap with protrusions that can be exchanged for a releasable cap that comprises at least one opening and a releasably sealable flap covering the at least one opening, and wherein the flap can be opened to expose the at least one opening. In another instance, the tool of this embodiment has a hollow body that further comprises at least one marker to indicate a volumetric measurement. In another instance, the tool of this embodiment has a hollow body that further comprises a plurality of markers designed to indicate graduated volumetric measurements. In another instance, the tool of this embodiment has one or more raised protrusions located on the bottom surface of the compartment that are spiked-shaped protrusions designed to tenderize a food item. In another instance, the tool of this embodiment has one or more raised protrusions that are designed to tenderize meat, fish, or poultry.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A multi-purpose kitchen tool comprising:
a hollow body having a distal and proximal end, the hollow body comprising:
an inner wall;
an outer wall;
a base at the distal end; and
at least one opening at the proximal end;
a handle connected to the outer wall of the body;
a tapered scooping edge on the proximal end of the body, the taper scooping edge being opposite to the handle; and
a compartment releasably fixed to the base.

2. The tool of claim 1, wherein the compartment is formed via a releasable cap that is releasably fixed to the body via mated threads.

3. The tool of claim 2, wherein the releasable cap further comprises at least one opening and a releasably sealable flap covering the at least one opening, and wherein the flap can be opened to expose the at least one opening.

4. The tool of claim 1, wherein the hollow body further comprises at least one marker to indicate a volumetric measurement.

5. The tool of claim 4, wherein the hollow body further comprises a plurality of markers designed to indicate graduated volumetric measurements.

6. A multi-purpose kitchen tool comprising:
a hollow body having a distal and proximal end, the hollow body comprising:
a cylindrically-shaped inner wall;
a cylindrically-shaped outer wall;
a base at the distal end; and
at least one opening at the proximal end;
a handle connected to the outer wall of the body;
a tapered scooping edge on the proximal end of the body, the taper scooping edge being opposite to the handle; and
a compartment releasably fixed to the base,
wherein the cylindrically-shaped outer wall further comprises one or more raised protrusions.

7. The tool of claim 6, wherein the compartment is formed via a releasable cap that is releasably fixed to the body via mated threads.

8. The tool of claim 7, wherein the releasable cap further comprises at least one opening and a releasably sealable flap covering the at least one opening, and wherein the flap can be opened to expose the at least one opening.

9. The tool of claim 6, wherein the hollow body further comprises at least one marker to indicate a volumetric measurement.

10. The tool of claim 9, wherein the hollow body further comprises a plurality of markers designed to indicate graduated volumetric measurements.

11. The tool of claim 6, wherein the one or more raised protrusions located on the cylindrically-shaped outer wall are spiked-shaped protrusions designed to tenderize a food item.

12. The tool of claim 11, wherein the one or more raised protrusions are designed to tenderize meat, fish, or poultry.

13. A multi-purpose kitchen tool comprising:
a hollow body having a distal and proximal end, the hollow body comprising:
a cylindrically-shaped inner wall;
a cylindrically-shaped outer wall;
a base at the distal end; and
at least one opening at the proximal end;
a handle connected to the outer wall of the body;
a tapered scooping edge on the proximal end of the body, the taper scooping edge being opposite to the handle; and
a compartment releasably fixed to the base, the compartment having a bottom surface,
wherein the bottom surface of the compartment further comprises one or more raised protrusions.

14. The tool of claim 13, wherein the compartment is formed via a releasable cap that is releasably fixed to the body via mated threads.

15. The tool of claim 14, wherein the releasable cap with protrusions can be exchanged for a releasable cap that comprises at least one opening and a releasably sealable flap covering the at least one opening, and wherein the flap can be opened to expose the at least one opening.

16. The tool of claim 13, wherein the hollow body further comprises at least one marker to indicate a volumetric measurement.

17. The tool of claim 16, wherein the hollow body further comprises a plurality of markers designed to indicate graduated volumetric measurements.

18. The tool of claim 13, wherein the one or more raised protrusions located on the bottom surface of the compartment are spiked-shaped protrusions designed to tenderize a food item.

19. The tool of claim 18, wherein the one or more raised protrusions are designed to tenderize meat, fish, or poultry.
